(19) United States
(12) Patent Application Publication
(10) Pub. No.: US 2002/0194193 A1
(43) Pub. Date: Dec. 19, 2002

(54) Method and system for sorting, storing, accessing and searching a plurality of audiovisual recordings

(76) Inventors: Gregg Edelmann, White Plains, NY (US); Adam Grayson, New Rochelle, NY (US); Douglas Pollok, San Antonio, TX (US)

Correspondence Address: BANIAK PINE & GANNON, Suite 1200, 150 N. Wacker Drive, Chicago, IL, 60606, US

(21) Appl. No.: 09/883,737

(22) Filed: Jun. 18, 2001

(51) Int. Cl. G06F 7/00

(52) U.S. Cl. 707/104.1

(57) ABSTRACT

A system for storing and accessing a plurality of scene parameters in a database of audiovisual recordings is disclosed. The system comprises a means for cataloguing a plurality of audiovisual recordings in the database. Additionally, the system comprises a means for cataloguing each parameter of each scene of each of the plurality of audiovisual recordings in the database. The system receives a search request, the search request including at least one search parameter, each of the search parameters corresponding to one of the scene parameters. Additionally, the system comprises a means for comparing the search request with the scene parameters in the database. Finally, the system comprises a means for selecting, identifying and displaying material for each of the plurality of audiovisual recordings having the parameters matching the search parameters.

### FIELD OF THE INVENTION

The present invention relates, generally, to systems for sorting, storing, accessing and searching databases, and, more particularly, to methods and systems for sorting, storing, accessing and searching a database of information describing audiovisual recordings, wherein the audiovisual recordings have previously been catalogued.

### BACKGROUND OF THE INVENTION

Currently, search techniques exist for searching a variety of audiovisual recordings. For example, one can request a list of all audiovisual recordings starring a particular actor/actress, produced by a particular production studio or distributed in a particular year. However, there currently is no available technique which allows one to search on a scene-by-scene basis. That is, one cannot search a database of audiovisual recordings via a particular scene. Similarly, it is currently not available to search such a database in accordance with certain sorted, or catalogued, aspects or parameters (i.e., settings, fetishes, props, etc.) of a particular scene contained within a desired audiovisual recording.

There, therefore, exists a need for a system for sorting, storing, accessing and searching a plurality of audiovisual recordings that overcomes the above-stated disadvantages.

### SUMMARY OF THE INVENTION

The present invention comprises a tool to assist users in choosing an audiovisual recording based on specific, user-inputted criteria about the audiovisual recording. To build this functionality, after researching which elements consumers look for in audiovisual recordings of a particular genre, a process has been developed for extracting data from the audiovisual recordings. Additionally, a process has been developed for archiving the information and storing the information in a large-scale relational database. Once the data has been collected, stored and properly formatted, the data then becomes accessible to subscribers (i.e., users and the like) through a front-end search engine.

To this end, one embodiment of the present invention comprises a system for storing, accessing and searching a plurality of parameters in a database of audiovisual recordings. The system comprises a means for cataloguing a plurality of audiovisual recordings in the database. Additionally, the system comprises a means for cataloguing the parameters associated with each of the plurality of audiovisual recordings in the database. Additionally, the system comprises a means for receiving a search request, the search request including at least one search parameter, each of the search parameters corresponding to one of the catalogued parameters. Additionally, the system comprises a means for comparing the search request with the parameters in the database. Finally, the system comprises a means for displaying each of the plurality of audiovisual recordings having the parameters matching the search parameters.

Another embodiment of the present invention comprises a method for storing a plurality of parameters from a plurality of audiovisual recordings in a database. One of the plurality of audiovisual recordings is received. Moreover, the audiovisual recording includes at least one of the plurality of parameters. The audiovisual recording is researched. Each of the parameters included in the audiovisual recording is then catalogued. Finally, each of the parameters included in the audiovisual recording is stored in the database in a memory location corresponding to the audiovisual recording.

Another embodiment of the present invention comprises a method for accessing a database of parameters included in a plurality of audiovisual recordings. A search request is received. The search request is compared with each of the parameters in the database. Finally, the audiovisual recordings corresponding to the matched parameters is displayed.

### BRIEF DESCRIPTION OF THE DRAWINGS

FIG. 1 illustrates a flow chart of a system for sorting, storing, accessing and searching a plurality of audiovisual recordings, generated in accordance with the present invention;

FIG. 2 illustrates a screen shot of an audiovisual recording information entry page, generated in accordance with system of the present invention;

FIG. 3 illustrates a screen shot of an audiovisual recording scene information entry page, generated in accordance with system of the present invention;

FIG. 4 illustrates a screen shot of an audiovisual recording page, generated in accordance with the system of the present invention;

FIG. 5 illustrates a screen shot of an actor biographical page, generated in accordance with the system of the present invention;

FIG. 6 illustrates one embodiment of an electronic communication node, made in accordance with the present invention;

FIGS. 7a and 7b illustrate a detailed search page of the electronic communication node of FIG. 6; and

FIG. 8 illustrates a level diagram of a set of databases in accordance with the system of the present invention.

### DETAILED DESCRIPTION OF A PRESENTLY-PREFERRED EMBODIMENT

The present invention comprises a system and method for sorting, storing, accessing and searching a plurality of audiovisual recordings. More specifically, the present invention is directed to a system for viewing a plurality of audiovisual recordings, cataloguing various parameters relating to each audiovisual recording, storing the various parameters as well as detailed information about each audiovisual recording in a database, searching the database in an effort to find a match with a set of parameters provided by a subscriber (or, alternatively, a user or searcher of the system of the present invention), and outputting the selected audiovisual recordings corresponding to the matched, user-inputted parameters.

As used herein, the phrase “audiovisual recordings” is intended to encompass Video Cassette Recorder (VCR) type tapes (in any type format), movie or film (i.e., motion picture) recordings, film reels, digital video recordings, Digital Versatile Disk (DVD) recordings, and indeed any medium whereby images (with or without audio) are captured in the manner of a “motion picture,” i.e., a movie.

Preferably, the audiovisual recordings that are the subject of the present invention comprise the genre of audiovisual recordings commonly known as “adult films.” Alternatively, the audiovisual recordings in the present invention may comprise other genres of audiovisual recordings presenting a demand or need to be catalogued, such as, for example, westerns, documentaries, action films, foreign films, etc.

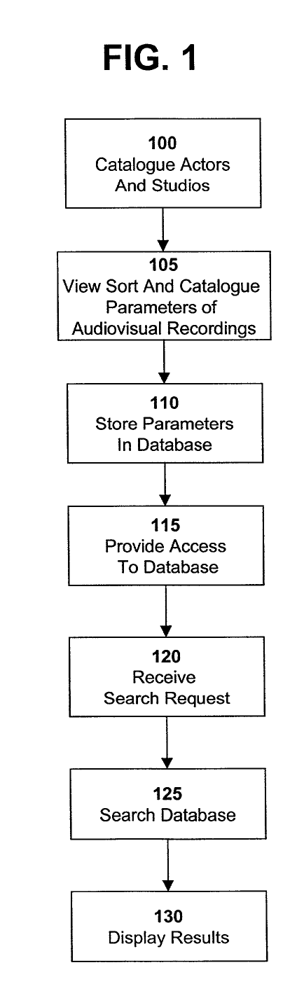

A description of the preferred operation of the system, in accordance with the present invention, follows. Reference may be made to FIG. 1, which illustrates a top-level flow chart depicting the operation of a system and method for sorting, storing, accessing and searching a plurality of audiovisual recordings, in accordance with the present invention.

Prior to receiving and viewing each audiovisual recording, a collection of pertinent information about the actors and actresses involved in the preferred genre of audiovisual recordings is cataloged and saved in a database. This step is illustrated in Block 100 of FIG. 1. Preferably, the database of information collected at this stage may be stored in any currently-known electronic means of storage, such as, for example, in a memory location located remote from, or integral with, an electronic communication node (the specifies of which will be described in detail below). Alternatively, the database may encompass any similar non-electronic means of information storage.

In the preferred embodiment, the information collected in Block 100 would include information relating to each adult film star appearing in adult films. The information would preferably be compiled from various sources (e.g., the performers and studios themselves, the Internet, trade magazines and other periodicals, newsletters, etc.), and would include such information as, for example, the actor's name (both actual and any aliases), race/ethnicity, hair color, eye color, measurements (including height, weight, breast size, penis length, other body measurements, etc.), tattoos, piercings, hometown, birthday, fan club address, Internet home page or World Wide Web (WWW) site, email address and any other relevant or biographically-related information, including answers to detailed personality and professional questionnaires, as well as various images of the actor/actress, including, for example, head shots and other perspectives.

Moreover, also within the scope of Block 100, a second collection—a studio collection—is also created and stored in a database. This “studio” database may be separate and apart from the first, or “actor” database, or the information may be stored in a single database. Similar to the actor's collection, above, the studio collection preferably includes pertinent information relating to the various production studios of the preferred genre of audiovisual recordings. For example, in the preferred embodiment, the studio collection may include information relating to the name of the adult film production studio, contact information, address, etc. Additionally, like the actor's collection, the information catalogued in the studio collection would be stored in the database. Preferably, hyperlinks, by means of a system such as Hyper Text Markup Language (HTML) links, or any known similar linking method, may provide a subscriber with access to each of these collections.

At this point, each audiovisual recording is received and viewed by researchers, and various parameters contained in that particular audiovisual recording are catalogued. This cataloguing process is illustrated in Block 105 in FIG. 1. The cataloguing is preferably accomplished through viewing the audiovisual recording and noting the existence of various pre-determined parameters relating to certain categories or divisions about the audiovisual recording. These parameters may also be gathered by reading scripts, direct data extraction, and various other sources for obtaining the required information. These parameters fall into two basic subtypes: general parameters and scene parameters. Both subtypes of parameters will be further discussed below. More specifically, the cataloguing of each audiovisual recording preferably comprises receiving the audiovisual recording, viewing the audiovisual recording and recording each of the parameters present in the audiovisual recording, such as, for example, specifics about the occurrence of the parameter (i.e., details of the parameter, location, etc.).

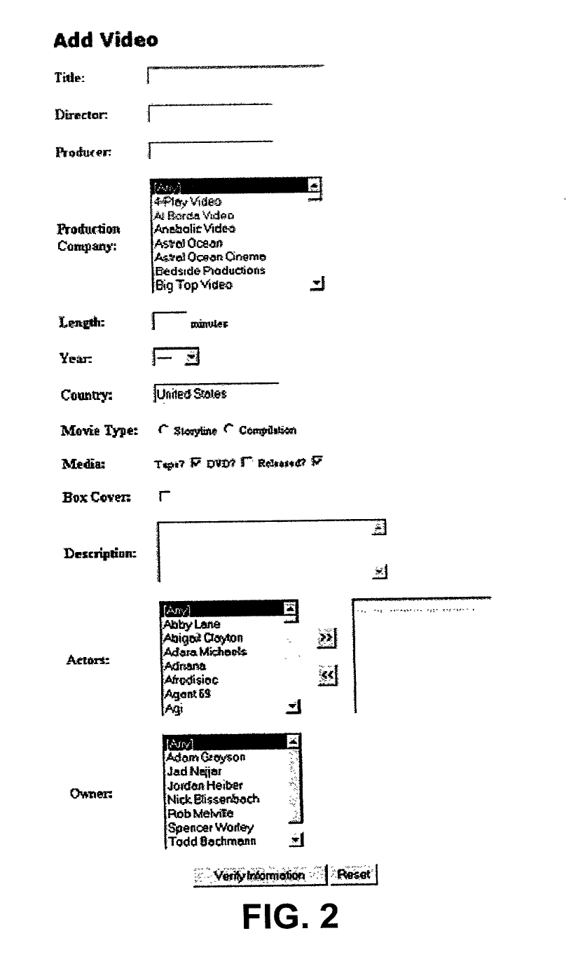

As mentioned above, one set of parameters comprises general audiovisual recording data that apply to the entire audiovisual recording. Such general audiovisual recording data, for example, may preferably include the title of the audiovisual recording, the year of production or release, the production studio, the director of the audiovisual recording, the producer of the audiovisual recording, the actors and actresses in the audiovisual recording, the length of the audiovisual recording, the media type (VHS, Betamax, DVD, film reel, etc.), the location of production and/or filming (city, country, etc.), the movie type (feature, compilation, etc.), a brief description of the movie, images from the front and back of the cover packaging and images taken either directly from the recording (“screen captures”) or from photographs taken during the production of the recording (“still photographs”), video clips, etc. Each general audiovisual recording data parameter is then saved to a database. An example of an audiovisual recording entry page is shown at FIG. 2. Although FIG. 2 shows the audiovisual recording entry page as an exemplary WWW page, such a page may be utilized in an alternative manner, such as, for example, manual entry (entering corresponding recording and parameter codes into a database interface, for example). Likewise, such an alternative manner applies to all “screen shots” within the present invention.

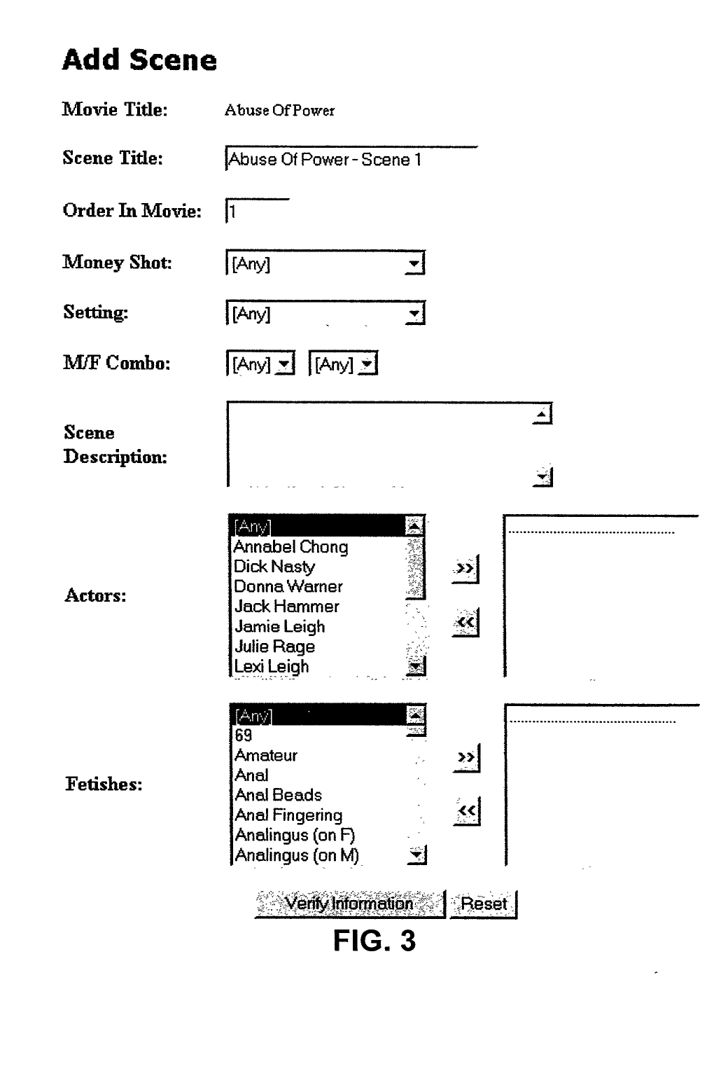

Next, the audiovisual recording is viewed and catalogued for the inclusion of an additional set of parameters. This second set, as mentioned above, compares the scene parameters. These additional parameters are more related to specific aspects of scenes of each audiovisual recording. An example of how information may preferably be collected at this stage (i.e., relating to specific aspects of the scenes) is shown in the screen shot of FIG. 3, which illustrates a preferred embodiment of an entry page for entering various aspects of a particular scene in an audiovisual recording into the database. For example, the set of parameters recorded at this time preferably include which actors/actresses are present, the setting of the scene, any “money shots” (i.e., where the male ejaculation lands), the ratio of men to women, the location of the scene in the audiovisual recording, a brief description of the scene, etc.

Each scene in the audiovisual recording is additionally detailed and documented for content. That is, this time, the catalogued parameters comprise any other aspects present in the scene not related to the general parameters discussed in the paragraph above. Thus, for example, in a preferred embodiment of the present invention, the parameters may include, without limitation, what sexual acts and/or positions are used (e.g., fellatio, cunnilingus, missionary, etc.), as well as what fetishes, if any, are present. For purposes of the present invention, a “fetish” is defined as anything other than a sexual act or position that a user may want to search for in a particular scene. Fetishes may range from traditional fetish-type acts (bondage, sado/masochism, toe-sucking, etc.) to descriptions of the actors/actresses (skin color, weight, amount of body hair, etc.), clothing items (stockings, cheerleader outfits, etc.), props (blindfolds, whips, cigarettes, etc.), as well as other a typical characteristics. The list of fetishes is not fixed, and may be increased or decreased as time and/or demand see fit, provided the potential fetish falls within the above-stated definition.

Finally, each audiovisual recording is documented according to the type of sexual act performed. These sex act parameters may include, in addition to traditional intercourse acts, non-sexual acts (i.e., no penetration of either the mouth, anus or vagina), masturbation-only scenes, lesbian-only scenes, anal or oral acts, double penetration (i.e., the simultaneous penetration of both the vagina and the anus), fisting (i.e., the insertion of the full hand into an orifice), urination, female ejaculation, etc. Preferably, this stage of cataloguing is effected on a “per performer” basis. This, for example, includes setting each of these attributes to either “true” or “false” for each performer in a scene and detailing whether or not that particular performer met that criteria (i.e., performed the scene).

Compiling a listing of parameters may initially be done by a programmer. However, additions to the parameters may occur over time, either by the programmer or by subscribers. In this way, the database may always be kept up to date with the most current information. If a parameter existing in an audiovisual recording is not already an option in the database, that parameter is added to this database for future use.

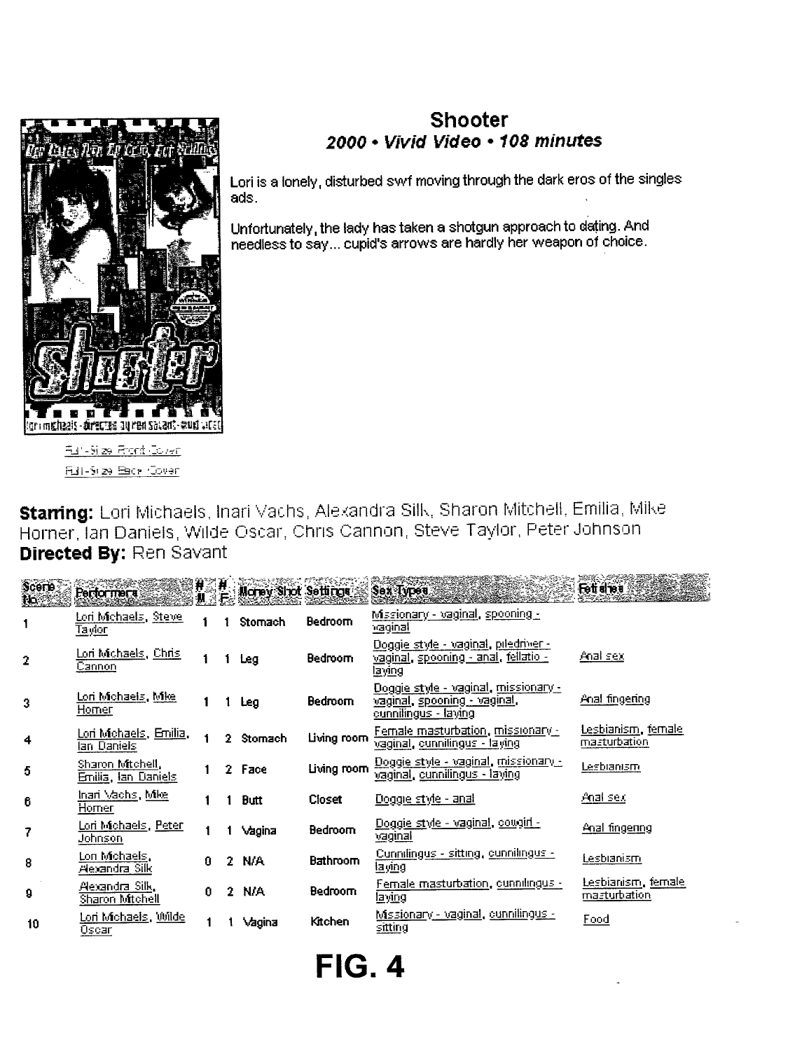

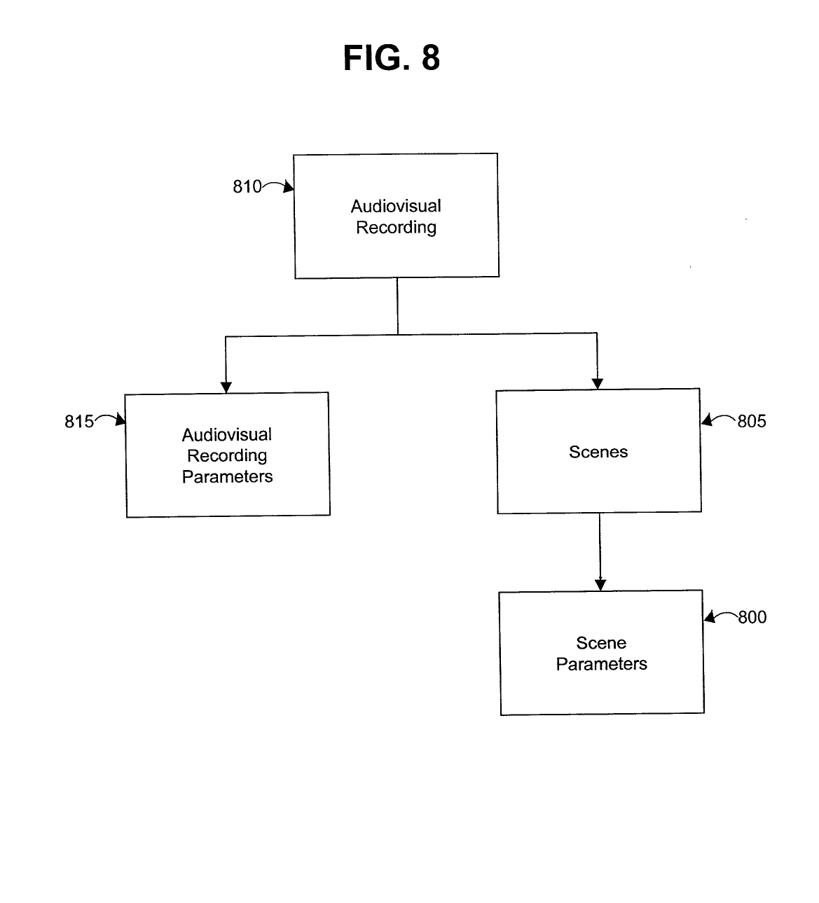

Upon cataloguing the various parameters described above for each audiovisual recording, the parameters of each audiovisual recording are then stored in a database. This is illustrated in Block 110 of FIG. 1. The database here may preferably be operated in conjunction with the database(s) alluded to above, and may be similar in style. Preferably, the audiovisual recording information is stored in the database via a three-level system. This is illustrated in FIG. 8. That is, the scene parameters 800 (which represent the third, or lowest, level) are stored in the database under the scene 805 of the audiovisual recording 810 in which the scene parameters 800 are present. The scenes 805 themselves represent one portion the second level of storage. The general audiovisual recording parameters 815, which apply to the entire audiovisual recording 810, represent the other portion of the second level of storage. The scenes 805 themselves as well as the general audiovisual recording parameters 815 are stored in the database under the general heading of the title of the audiovisual recording 810 (which represents the first level) to which the general audiovisual recording parameters 815 apply and in which the scenes 805 are contained. In this way, a subscriber may access a particular audiovisual recording title and view all the recorded parameters corresponding to that particular title. An example of such an access page is illustrated in the screen shot of FIG. 4.

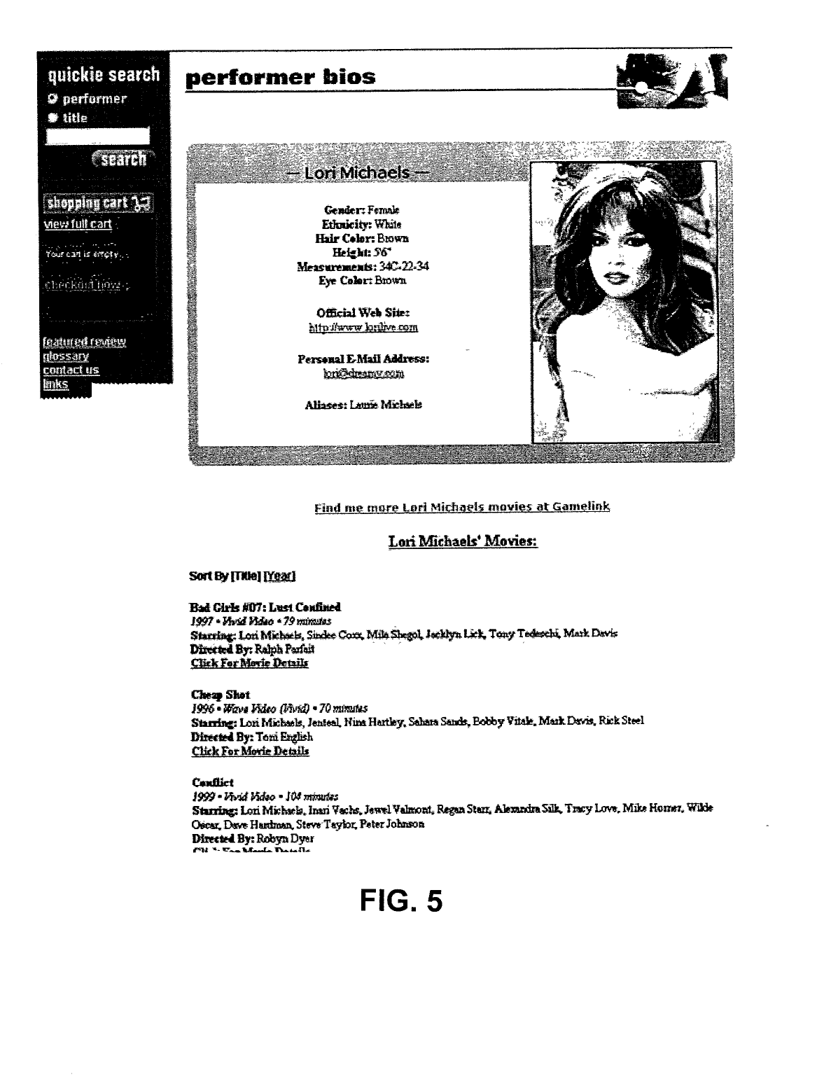

In addition, hyperlinks may be provided between the actors/actresses and studio in a particular audiovisual recording to the actor and studio database(s), described above. In this way, a subscriber accessing a particular audiovisual recording may link, via a HTML or similar hyperlink, to an actor's biographical page, as stored in the actor database, above. An example of a link to an actor's biographical page is illustrated in the screen shot of FIG. 5. Preferably, the databases may be located on an electronic medium, such as, for example, the Internet. Alternatively, the databases may be stored on any other medium capable of being accessed by a subscriber.

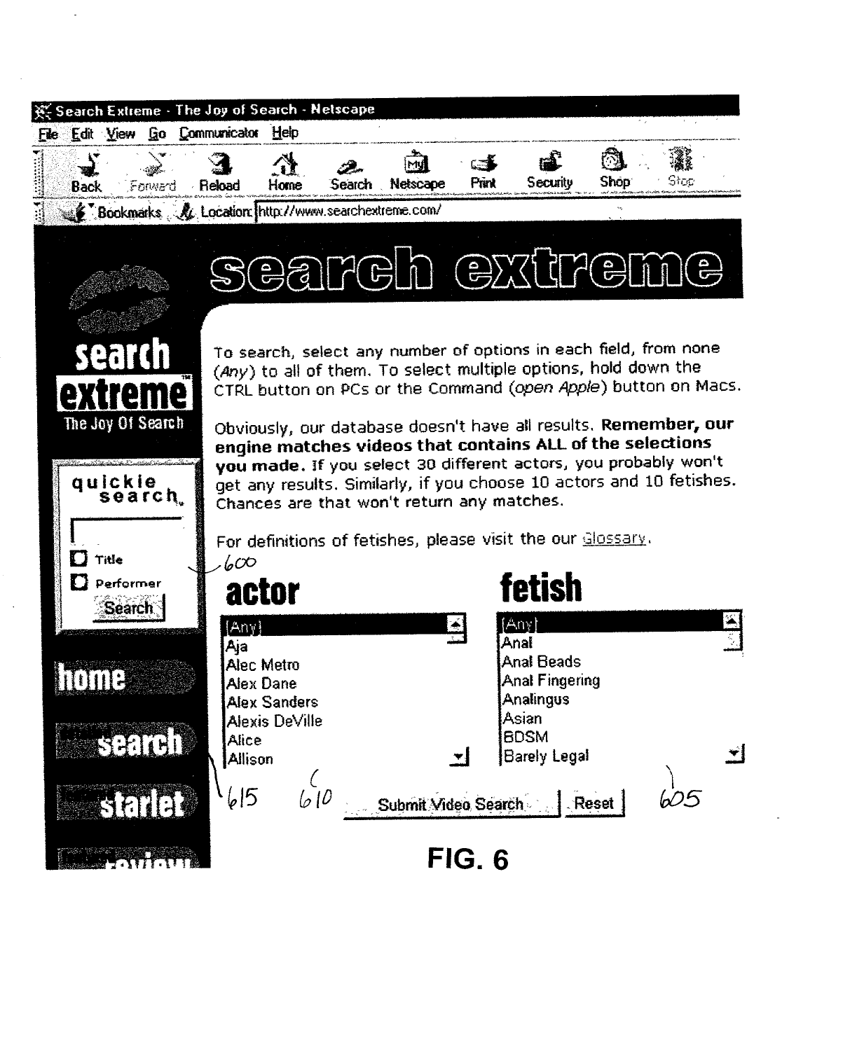

Once the audiovisual recording (and any corresponding parameters) has been catalogued and stored on the database, the database becomes accessible by a subscriber to an electronic communication node having access to the database for the potential searching of the database. This step is illustrated by Block 115 of FIG. 1. Preferably, the electronic communication node may be an Internet or WWW site, or some similar centralized entity having the ability to possess access to an electronic database. Further, the subscriber may be a user who possesses an account with the electronic communication node (such as one requiring, for example, a login name and/or a password), or the electronic communication node may provide free access to all users. An example of a preferred embodiment of an electronic communication node is shown in the screen shot of FIG. 6, which shows a “Home Page” screen shot for a preferred embodiment of the present invention.

Preferably, the technical facilitation of the present invention may be occasioned through industry-standard technologies, including, interalia, various Internet browsers (i.e., Netscape Navigator™, Microsoft Internet Explorer™, etc.), HTML, TCP/IP (Transmission Control Protocol/Internet Protocol) VBScript language, Active Server Page standards, Structured Query Language (SQL) standards, Open Database Connectivity (ODBC) standards, OLE (Object Linking and Embedding), Common Gateway Interface (CGI) standards, ActiveX Data Objects (ADO) standards, and Document Object Model (DOM) standards. This facilitation is preferably done via a communication device (e.g., a personal computer) communicating with an electronic communication node (e.g., a WWW site). In addition to the personal computer and Internet-based application, the database may be accessed by users in the same fashion through kiosk stations running proprietary operating systems and software, digital appliances, as well as handheld computing tools. Furthermore, all data contained in the databases are preferably stored in and accessed through a standard ODBC-compliant relational database, using many tables and data relations. Examples of these include Microsoft SQL Server 2000™ and Microsoft Visual FoxPro 6.0™.

In any event, once the subscriber has accessed the electronic communication node, the subscriber is presented with a series of search parameter options matching the parameters contained in the database alluded to above. The subscriber then enters which of the specific search parameters the subscriber wishes the present invention, as provided on the electronic communication node, to search, in the form of a search request. This is illustrated in Block 120 of FIG. 1.

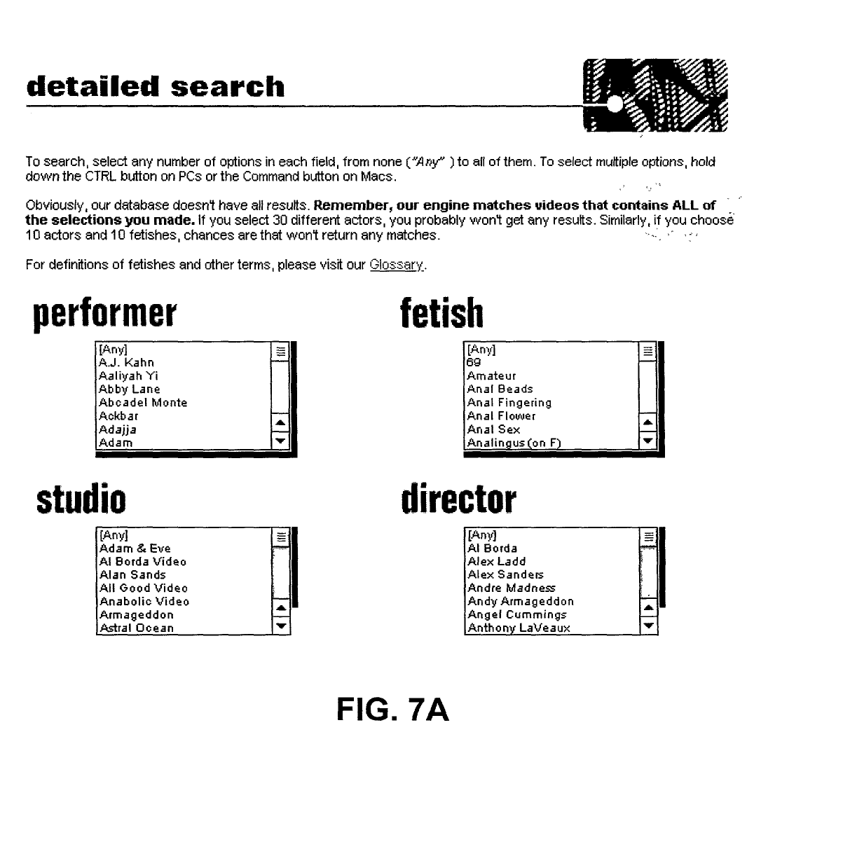

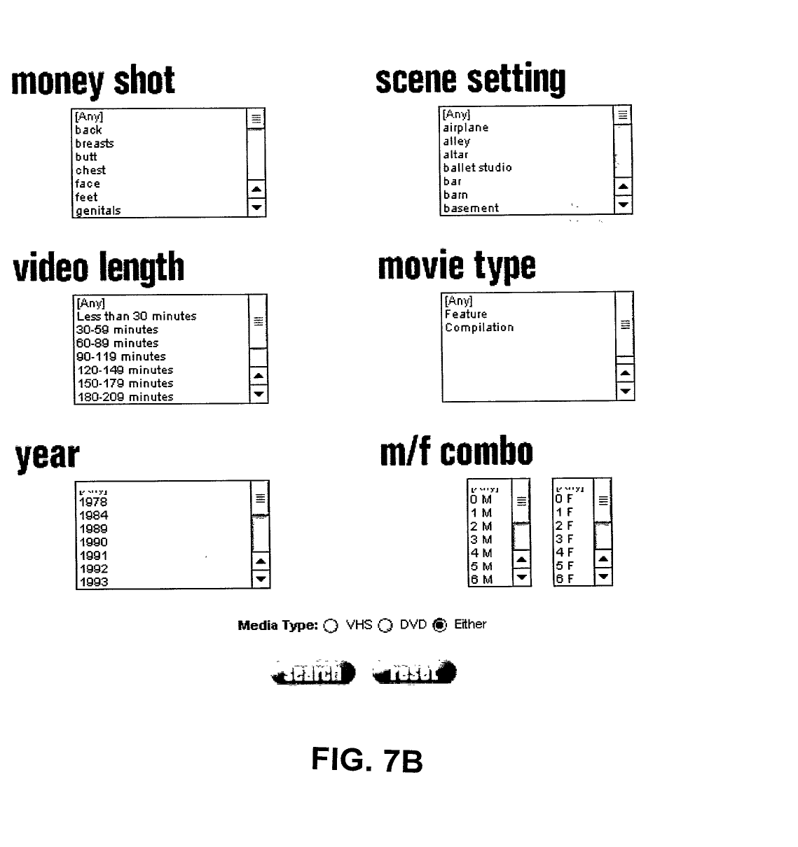

Preferably, the subscriber has at least three options upon accessing the electronic communication node. First, the subscriber may search the audiovisual recording based on a single actor/actress or the title of an audiovisual recording. This is preferably known as a “Quickie Search,” and is shown in FIG. 6 at reference numeral 600. Second, the subscriber may input desired information relating to a plurality of actors/actresses, as well as a plurality of fetishes. This is shown in FIG. 6 at reference numerals 605 and 610. Finally, to obtain a detailed search, the subscriber may input desired information relating to at least one of the other catalogued parameters alluded to above. This is shown in the screen shot of FIGS. 7a and 7b, which may be accessed by “clicking” on the “Detailed Search” button at reference numeral 615 of FIG. 6. Another method of access the information may be through a simplified method of associating an actor/actress with one of a subset of parameters. For instance, a user may search for “X doing Y” through a simple interface (i.e., “Lori Michaels doing anal.”).

Upon receiving the search parameters from the subscriber contained in the search request, the present invention preferably conducts a Boolean search (using “and,” “or” or “not” as the conjunction, as the circumstances warrant) of the database. That is, the present invention compares the search parameters received in the search request with the parameters in the database in an attempt to find a match, and, if found, outputs the audiovisual recording page corresponding to the matched parameter(s). This step is illustrated in Block 125 of FIG. 1.

In the case in which a parameter is not selected for a particular search aspect, that particular search aspect is ignored. That is, for example, if the subscriber does not designate a preferred scene setting, the search proceeds with no limitations on scene settings. Likewise, multiple selections of a single parameter involves the “or” conjunction. Additionally, the Boolean “not” conjunction may be used to exclude recordings that match certain parameters. For example, using the “not” conjunction with the anal sex fetish would exclude all movies containing scenes which included anal sex.

It should be noted that some parameters are limited in the number that can be selected, while others are unrestricted. For example, an audiovisual recording cannot be produced and/or released in both 1995 and 1996, so the production year is limited to one entry. However, a range can be searched using the Boolean “or” conjunction. For instance, the range of 1995-1996 can be searched to find all audiovisual recordings produced in either of those two years. Use of different Boolean conjunction gives users added options for searching through the collection of recordings. For example, an audiovisual recording may possess a lesbian scene and a ménage à trois scene. As a result, the subscriber may select either, or both, parameters to select the audiovisual recording.

Upon performing the Boolean search, a page of results is returned and displayed for the subscriber. In such a case, the audiovisual recordings are preferably displayed which contain all the search parameters listed in the search request. Alternatively, the system may display the audiovisual recordings containing at least one search parameter, organized by accuracy of the matches, or through any other sorting means. This is illustrated in Block 130 of FIG. 1. Also, the page may include hyperlinks to various aspects of the audiovisual recordings. Optionally, the subscriber may be given the option of refining the search, in the cases in which too few or too many results were obtained by the search. Additionally, the subscriber may be given the option to select one of the displayed audiovisual recordings, which is then displayed, showing the parameters contained within that audiovisual recording.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

We claim:

1. A method for storing a plurality of parameters from a plurality of audiovisual recordings in a relational database, comprising:
receiving one of the plurality of audiovisual recordings, the audiovisual recording including at least one of the plurality of parameters;
researching the audiovisual recording;
cataloguing each of the at least one of the plurality of parameters included in the audiovisual recording; and
storing each of the parameters included in the audiovisual recording in the database in a memory location corresponding to the audiovisual recording.

2. The method of claim 1, further comprising organizing the database via a title of each of the audiovisual recordings.

3. The method of claim 2, further comprising storing each of the parameters in the database according to the audiovisual recording in which the parameter is included.

4. The method of claim 1, further comprising storing the database at a centralized location.

5. The method of claim 1, further comprising storing the database on an electronic communication node.

6. The method of claim 1, further comprising storing the database on the Internet and other electronic mediums.

7. The method of claim 1, wherein each of the plurality of audiovisual recordings is selected from a group consisting of motion pictures, videotapes, digital video recordings and Digital Versatile Discs.

8. The method of claim 1, wherein each of the plurality of audiovisual recordings is an adult film.

9. A method for accessing a database of parameters included in a plurality of audiovisual recordings, comprising:
receiving a search request;
comparing the search request with each of the parameters in the database;
matching the search request with parameters in the database; and
displaying identifying material for the audiovisual recordings corresponding to the matched parameters.

10. The method of claim 9, wherein the search request includes at least one search parameter.

11. The method of claim 10, further comprising displaying the identifying material for the audiovisual recordings matching all the search parameters in the search request.

12. The method of claim 9, further comprising displaying each audiovisual recording having at least one parameter matching the search request.

13. The method of claim 9, further comprising prompting for a selection of one of the displayed audiovisual recordings.

14. The method of claim 13, further comprising displaying each of the parameters corresponding to the selected audiovisual recording.

15. The method of claim 9, further comprising receiving the search request from a communication device.

16. The method of claim 9, further comprising receiving the search request at an electronic communication node.

17. The method of claim 16, wherein the electronic communication node comprises an electronic database.

18. The method of claim 16, wherein the electronic communication node comprises an Internet site.

19. The method of claim 9, wherein each of the parameters are drawn from a group consisting of actors/actresses, date of production, studio of production, scene settings, money shots, acts done by specific performers, items of clothing, performer attributes, props and fetishes.

20. A system for storing and accessing a plurality of parameters in a database of audiovisual recordings, comprising:
means for cataloguing a plurality of audiovisual recordings in the database;
means for cataloguing the parameters associated with scenes of the plurality of audiovisual recordings in the database as scene parameters;
means for receiving a search request, the search request including at least one search parameter, each of the search parameters corresponding to an aspect of the audiovisual recordings;
means for comparing the search request with the scene parameters in the database; and
means for displaying identifying material for each of the plurality of audiovisual recordings having the scene parameters matching the search parameters in the search request.
